(19) United States
(12) Patent Application Publication
(10) Pub. No.: US 2023/0410133 A1
(43) Pub. Date: Dec. 21, 2023

(54) AREA REVITALIZATION APPARATUS AND AREA REVITALIZATION METHOD

(71) Applicant: HITACHI, LTD., Tokyo (JP)

(72) Inventors: Kazushige HIROI, Tokyo (JP); Tomoyuki MOCHIZUKI, Tokyo (JP); Kie IWAMATSU, Tokyo (JP)

(21) Appl. No.: 18/315,848

(22) Filed: May 11, 2023

(30) Foreign Application Priority Data
May 19, 2022 (JP) 2022-082554

(51) Int. Cl. G06Q 30/0204; G06Q 30/0226; G06Q 10/0639

(52) U.S. Cl. CPC G06Q 30/0205; G06Q 10/06393; G06Q 30/0226

(57) ABSTRACT

An object of the invention is to actively increase movement of customers between areas. An area revitalization apparatus according to the invention includes: a store placement unit configured to change a placement of a store in an area based on movement information on a customer and information on purchase of products by the customer, and display, to the customer, a screen for visiting the store in the area; and a point giving unit configured to give an economic value to the customer who actually visits the store in the area.

### CROSS-REFERENCE TO RELATED APPLICATION

The present application claims priority from Japanese application JP2022-082554, filed on May 19, 2022, the contents of which is hereby incorporated by reference into this application.

### BACKGROUND OF THE INVENTION

### 1. Field of the Invention

The present invention relates to an area revitalization apparatus and an area revitalization method.

### 2. Description of Related Art

In Japan, a population tends to decrease over a long period of time, and prevention of spread of an infection disease is being thoroughly addressed over a short period of time. For these reasons, the number of people going out on streets is reduced, and earnings of a store business operator and a transportation business operator are also reduced. It is apparent that infection is to be converged, but in such a situation, it is an urgent matter from a national economical viewpoint how to get people to go out and go to stores.

A mobile store car placement determination apparatus described in JP7027933B determines placement of a plurality of mobile store cars (self-propelled stands) in a wide free space such as an event venue. For example, during a time when many elderly women are likely to gather, the apparatus places a store targeting the elderly women in a back area as seen from an entrance. This is because it is empirically known that many elderly women visit most stores regardless of purchasing or using services.

For example, during a time when many elderly men are likely to gather, the apparatus places a store targeting the elderly men in a front area as seen from the entrance. This is because it is empirically known that many elderly men head for a target store, finish their shopping there, and then go home without stopping at other stores.

It is apparent that an area business association and a transportation business operator who is also engaged in area development around transportation hubs such as a station may adopt a concept of JP7027933B and replace the store in the area. However, the placement determination apparatus of JP7027933B does not have a viewpoint of actively working on customers. As a result, sales of the store after the placement change depends on the customers. Further, although JP7027933B focuses on maximizing the sales inside the event venue, it lacks an idea of making the entire area including the event venue known to people in other areas.

### SUMMARY OF THE INVENTION

Accordingly, an object of the invention is to actively increase movement of customers between areas.

An area revitalization apparatus according to the invention includes: a store placement unit configured to change a placement of a store in an area based on movement information on a customer and information on purchase of products by the customer, and display, to the customer, a screen for visiting the store in the area; and a point giving unit configured to give an economic value to the customer who actually visits the store in the area.

Other units will be described in the description of embodiment.

According to the invention, it is possible to actively increase the movement of the customers between the areas.

### BRIEF DESCRIPTION OF THE DRAWINGS

FIG. 1 is a diagram illustrating a configuration and the like of an area revitalization apparatus;

FIG. 2 is a diagram illustrating an area;

FIG. 3 is an example of purchase information;

FIG. 4 is an example of OD information;

FIG. 5 is an example of movement information;

FIG. 6 is an example of point information;

FIG. 7 is an example of a store guidance screen;

FIG. 8 is an example of the store guidance screen; and

FIG. 9 is a flowchart of a processing procedure.

### DESCRIPTION OF EMBODIMENTS

Hereinafter, an embodiment of the invention (referred to as “the present embodiment”) will be described in detail with reference to the drawings and the like. The present embodiment is an example in which a transportation business operator revitalizes an area around a station. Revitalization means increasing a flow of people, and as a result, earnings of area business operators and transportation business operators are increased.

### (Area Revitalization Apparatus)

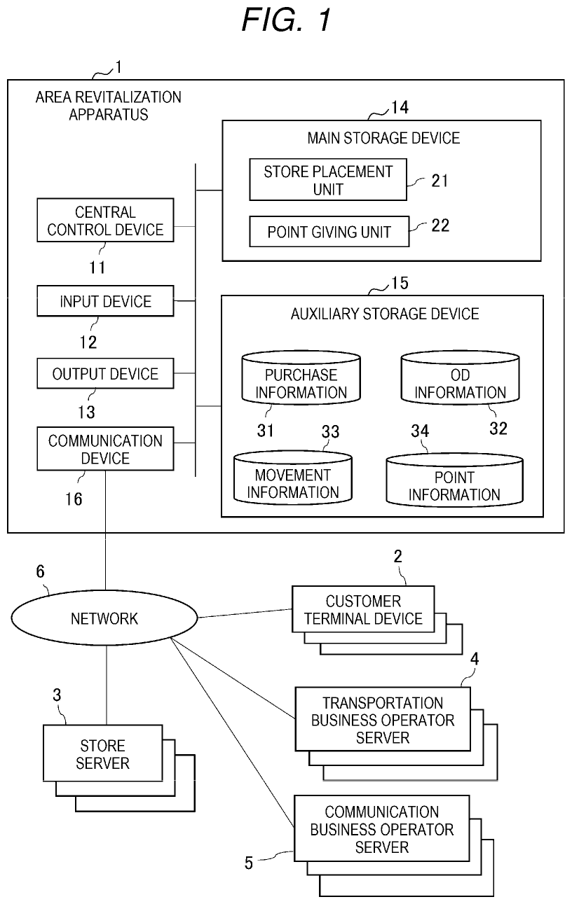

FIG. 1 is a diagram illustrating a configuration and the like of an area revitalization apparatus 1. The area revitalization apparatus 1 is a general computer, and includes a central control device 11, an input device 12 such as a microphone, a mouse, and a keyboard, an output device 13 such as a speaker and a display, a main storage device 14, an auxiliary storage device 15, and a communication device 16. These devices are connected to each other by a bus. The auxiliary storage device 15 stores purchase information 31, origin destination (OD) information 32, movement information 33, and point information 34 (details will be described later).

A store placement unit 21 and a point giving unit 22 in the main storage device 14 are programs. The central control device 11 reads out these programs from the auxiliary storage device 15 and loads these programs into the main storage device 14, thereby implementing functions of the programs (details will be described later). The auxiliary storage device 15 may be independent from the area revitalization apparatus 1. The area revitalization apparatus 1 can communicate with a customer terminal device 2, a store server 3, a transportation business operator server 4, and a communication business operator server 5 via a wired or wireless network 6.

The customer terminal device 2 is a computer carried by a customer. The customer is an individual who visits a store in an area, and is also a passenger of transportation (railway line, route bus, or the like) that leads to the area. The store server 3 is a computer by which the store in the area manages the purchase information 31. The transportation business operator server 4 is a computer by which the transportation business operator manages the OD information 32. The communication business operator server 5 is a computer by which the communication business operator manages the movement information 33.

### (Area)

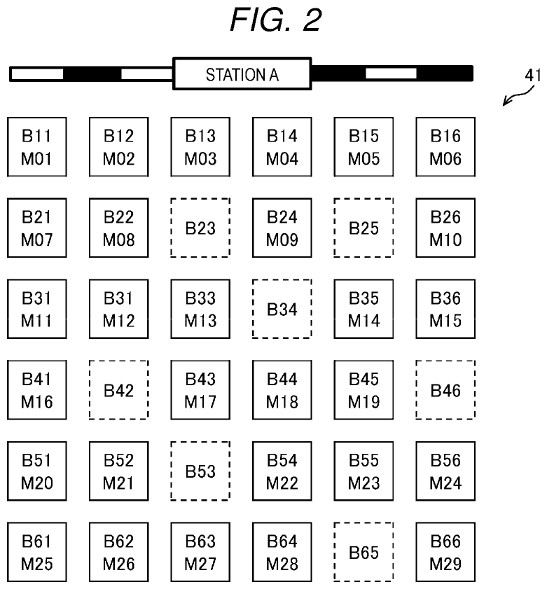

FIG. 2 is a diagram illustrating an area. An area 41 is, for example, a commercial area spreading on one side of a station A of a railway line. A location ID (B11, B12, . . . , B66), which is an identifier that uniquely identifies a section, is assigned to each section defined by roads that extend horizontally and vertically. One store can occupy in one section. The customer who gets out of the station A can walk on the roads in the area 41 at a shortest distance toward a specific store, or can stroll (excurse) along the roads without any particular purpose.

A store ID, which is an identifier that uniquely identifies a store, is assigned to each store. Among a total of 36 sections in FIG. 2, one location ID and one store ID are assigned to the section B11 or the like indicated by a solid line. Only one location ID is assigned to the section B23 or the like indicated by a broken line. This indicates that a store is occupied in the section indicated by the solid line and no store is occupied in the section indicated by the broken line. The area in FIG. 2 is simplified for a purpose of explanation. In an actual area, it is rare for roads to run in a grid pattern as illustrated in FIG. 2, and a plurality of stores may occupy in one section. Further, sections may be present on two sides of the railway.

### (Purchase Information)

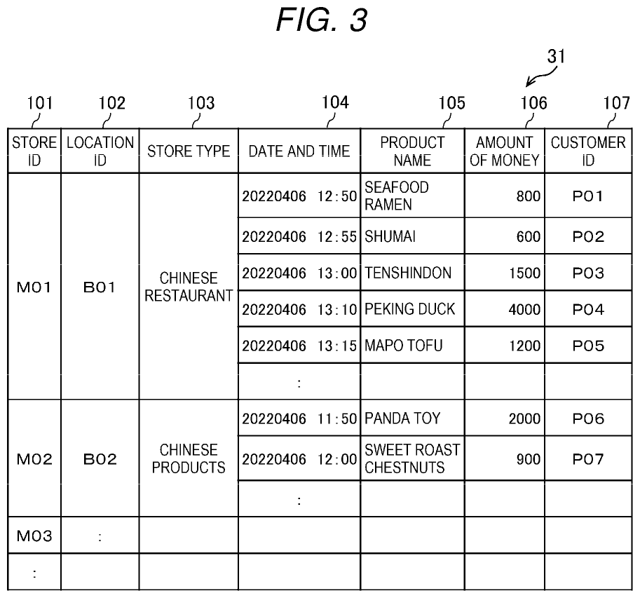

FIG. 3 is an example of the purchase information 31. In the purchase information 31, in association with the store ID stored in a store ID field 101, the location ID is stored in a location ID field 102, a store type is stored in a store type field 103, date and time is stored in a date and time field 104, a product name is stored in a product name field 105, an amount of money is stored in an amount of money field 106, and a customer ID is stored in a customer ID field 107.

The store ID in the store ID field 101 is the store ID described above.

The location ID in the location ID field 102 is the location ID described above.

The store type in the store type field 103 is a type of a store.

The date and time in the date and time field 104 is year, month, day, hour, and minute at the time when a product is sold.

The product name in the product name field 105 is a name of the product. When a plurality of products having the same product name are sold, a quantity is stored in the field.

The amount of money in the amount of money field 106 is an amount of money of a product. When a plurality of products having the same product name are sold, a total amount of money is stored in the field.

The customer ID in the customer ID field 107 is an identifier that uniquely identifies a customer who purchased a product. However, the customer ID here cannot specify personal information (name or the like) of the customer.

### (Od Information)

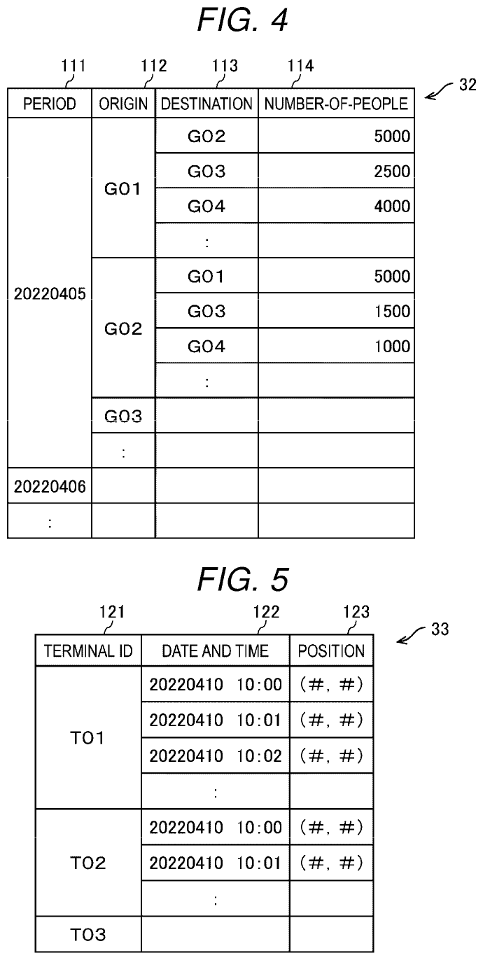

FIG. 4 is an example of the OD information 32. In the OD information 32, in association with a period stored in a period field 111, an origin is stored in an origin field 112, a destination is stored in a destination field 113, and the number of people is stored in a number-of-people field 114.

The period in the period field 111 is a period of any length serving as a unit that measures a passenger flow. In the example of FIG. 4, the period is “one day”, and FIG. 4 illustrates a date as the period.

The origin in the origin field 112 is a station ID of a station where the customer (passenger) got on. The station ID is an identifier that uniquely identifies a station.

The destination in the destination field 113 is a station ID of a station where the customer (passenger) got off.

The number of people in the number-of-people field 114 is the number of customers (passengers) who get on at the station of the origin and get off at the station of the destination. The number of people is obtained by counting the number of people passing through a ticket gate of each station.

A record of the OD information 32 has directionality of “up” and “down”. That is, for example, a record having an origin G01 and a destination G02 and a record having an origin G02 and a destination G01 are separately managed. However, both the number of people is substantially the same.

### (Movement Information)

FIG. 5 is an example of the movement information 33. In the movement information 33, in association with a terminal ID stored in a terminal ID field 121, date and time is stored in a date and time field 122, and a position is stored in a position field 123.

The terminal ID field 121 is an identifier that uniquely identifies the customer terminal device 2. When one customer carries one customer terminal device 2, the terminal ID is substantially synonymous with the customer ID in FIG. 2. It is apparent that the communication business operator manages the terminal ID not for a purpose of acquiring personal information but for a public purpose of analyzing the flow of people.

The date and time in the date and time field 122 is year, month, day, hour, and minute at a time point when the position of the customer terminal device 2 is measured.

The position in the position field 123 is a position (latitude and longitude) of the customer terminal device 2. The customer terminal device 2 measures the position of the customer terminal device 2 by acquiring radio waves from a plurality of communication satellites under approval of the customer, and transmits the position to the communication business operator server 5 via the network 6. “If” indicates different numerical values in an omitted manner.

### (Point Information)

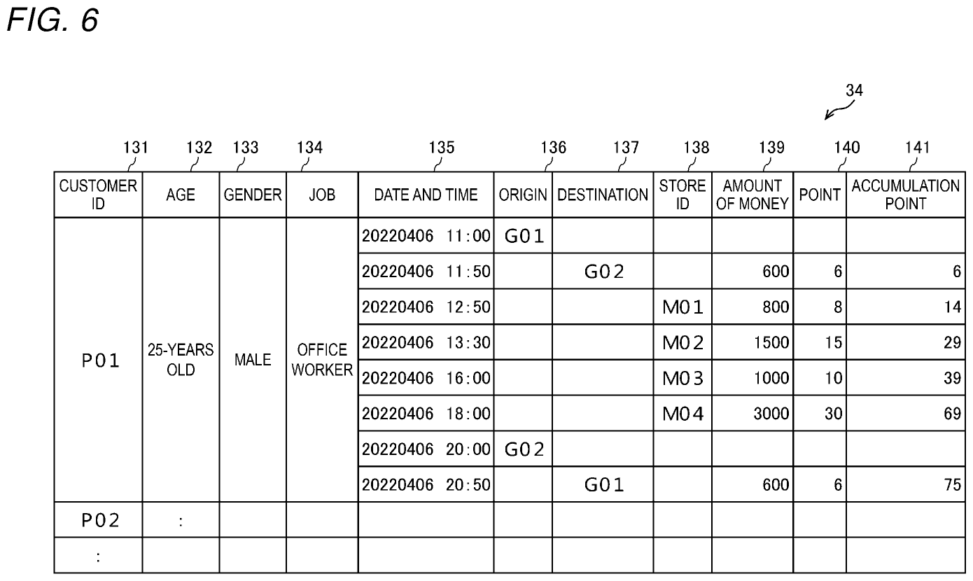

FIG. 6 is an example of the point information 34. In the point information 34, in association with the customer ID stored in a customer ID field 131, an age is stored in an age field 132, gender is stored in a gender field 133, a job is stored in a job field 134, date and time is stored in a date and time field 135, an origin is stored in an origin field 136, a destination is stored in a destination field 137, a store ID is stored in a store ID field 138, an amount of money is stored in an amount of money field 139, a point is stored in a point field 140, and an accumulation point is stored in an accumulation point field 141.

The customer ID in the customer ID field 131 is the same as the customer ID in FIG. 3. Here, the customer approves disclosure of minimum personal information sufficient to give a point.

The age in the age field 132 is an age of the customer.

The gender in the gender field 133 is gender of the customer.

The job in the job field 134 is a job of the customer.

The date and time in the date and time field 135 are year, month, day, hour, and minute at the time point when the customer passes through the ticket gate of the destination station.

The origin in the origin field 136 is the same as the origin in FIG. 4.

The destination in the destination field 137 is the same as the destination in FIG. 4.

The store ID in the store ID field 138 is the store ID described above.

The amount of money in the amount of money field 139 is an amount of money of a fare paid by the customer at the destination station, or an amount of money of the product or the like purchased by the customer at the store.

The point in the point field 140 is an economic value (electronic money) given to the customer according to the amount of money. The point is a reward (incentive) for the customer who paid the fare of the railway or purchased the product or the like at the store.

The accumulation point in the accumulation point field 141 is an accumulation amount of points.

In the present embodiment, an “attribute” includes not only a property of a category to which the customer belongs, such as the age, the gender, and the job, but also a behavior characteristic of the customer.

Focusing on FIG. 6, the following information can be seen.
On Apr. 6, 2022, a customer P01 got on a train at the station G01 and got off at station G02. The fare was 600 yen.
Thereafter, the customer P01 visited a store M01, a store M02, a store M03, and a store 04 in this order, and spent 800 yen, 1500 yen, 1000 yen, and 3000 yen at respective stores.
Thereafter, the customer P01 got on the train at the station G02 and got off at station G01. The fare was 600 yen.
As a result, 75 points were given to the customer P01.

### (Store Guidance Screen)

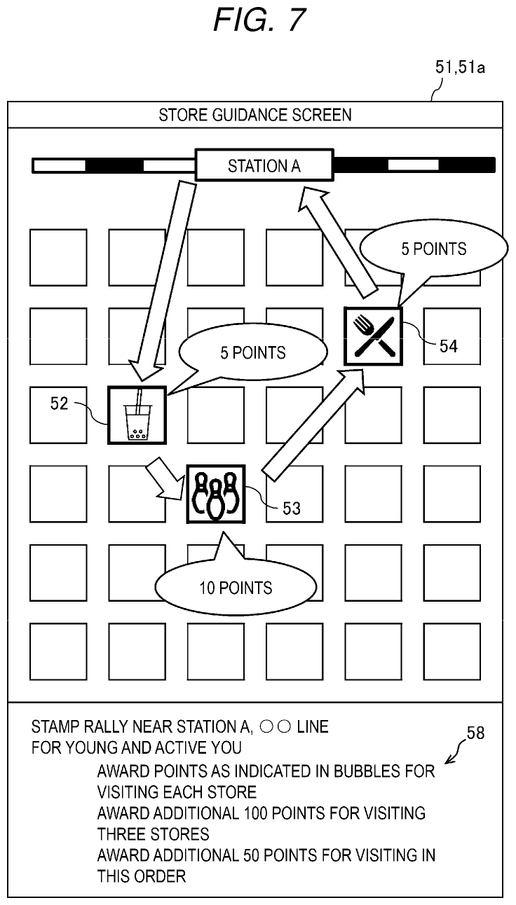

FIG. 7 is an example of a store guidance screen 51. The area revitalization apparatus 1 displays, on the customer terminal device 2 of a target customer having a certain attribute (a young and exercise-loving male), a store guidance screen 51a that recommends visiting three newly replaced stores. The area revitalization apparatus 1 recommends the following excursion to the target customer in this order.
The target customer gets off at the station A.
The target customer goes to a cafe 52 to meet up with a friend.
The target customer goes to a bowling alley 53 together with the friend.
The target customer goes to a restaurant 54 together with the friend.

A reason why the area revitalization apparatus 1 first recommends meeting at the cafe 52 is to increase sales in the cafe 52 and the subsequent stores. A reason why the area revitalization apparatus 1 recommends going to the restaurant 54 after the bowling alley 53 is that in the opposite case, sales of alcoholic beverages of the restaurant 54 do not increase, and a feeling of fullness after eating shortens game time at the bowling alley 53. The area revitalization apparatus 1 proposes a reward point giving in order to guide the target customer to such excursion (a reference numeral 58).

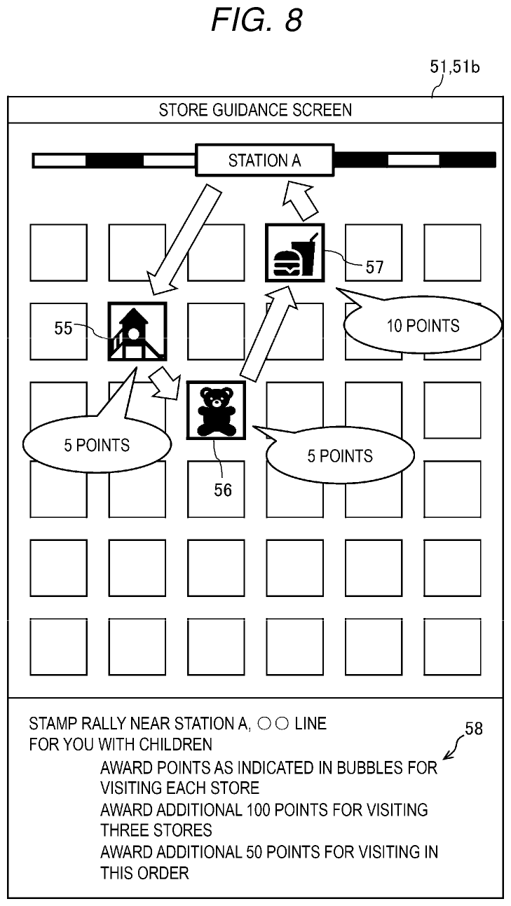

FIG. 8 is also an example of the store guidance screen 51. The area revitalization apparatus 1 displays, on the customer terminal device 2 of the target customer having another attribute (a mother with a child), a store guidance screen 51b that recommends visiting other three newly replaced stores. The area revitalization apparatus 1 recommends the following excursion to the target customer in this order.
The target customer gets off at the station A.
The target customer goes to a gaming hall 55.
The target customer goes to a toy store 56.
The target customer goes to a fast food store 57.

A reason why the area revitalization apparatus 1 recommends going to the gaming hall 55 first is to make the child aware that there is the toy store 56 nearby. A reason why the area revitalization apparatus 1 recommends going to the fast food store 57 after the toy store 56 is that the child is fascinated by a toy he/she just bought and eats quietly. The area revitalization apparatus 1 proposes a reward point giving in order to guide the target customer to such excursion (the reference numeral 58).

### (Processing Procedure)

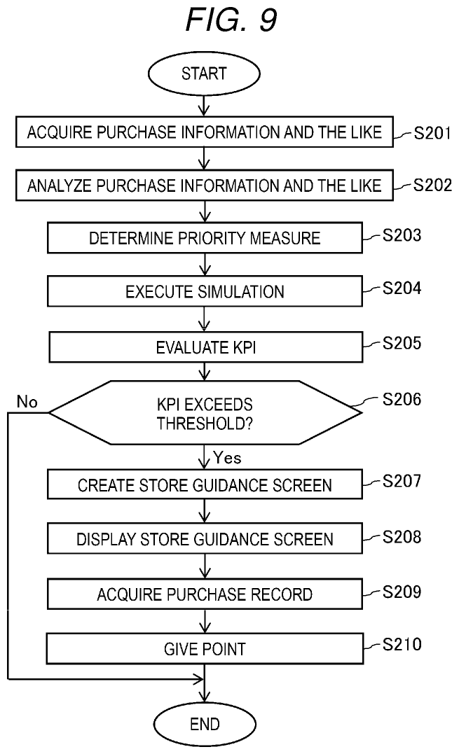

FIG. 9 is a flowchart of a processing procedure. As a premise for starting the processing procedure, it is assumed that the store server 3 stores the purchase information 31, the transportation business operator server 4 stores the OD information 32, and the communication business operator server 5 stores the movement information 33, respectively, in a latest state.

In step S201, the store placement unit 21 of the area revitalization apparatus 1 acquires the purchase information 31 and the like. Specifically, the store placement unit 21 acquires the purchase information 31 from the store server 3, the OD information 32 from the transportation business operator server 4, and the movement information 33 from the communication business operator server 5, respectively, in the latest state.

In step S202, the store placement unit 21 analyzes the purchase information 31 and the like. Specifically, the store placement unit 21 analyzes the purchase information 31, the OD information 32, and the movement information 33 by any method. For example, it is assumed that the store placement unit 21 recognizes the following information as a result of comparing and analyzing areas of a predetermined acreage including each station on a certain railway line.
The number of restaurants in an area around the station A is less than that in areas around other stations.
The flow of people around the station A is less than that in the areas around other stations.
The number of young males getting on and off at the station A is less than that at other stations.

In step S203, the store placement unit 21 determines a priority measure. Specifically, the store placement unit 21 determines the priority measure based on the analysis result of step S202. Here, the priority measure is, for example, “to let a young male to excurse restaurants around the station A.” In the priority measure, the “around the station A” is called a target area, the “young male” is called a target customer, and the “restaurants” for the target customer are called target stores. Other stores (for example, reference numerals 52 and 53 in FIG. 7) contributing to an increase in sales amount of a certain target store (for example, reference numeral 54 in FIG. 7) are also called target stores.

In step S204, the store placement unit 21 executes a simulation. Specifically, the store placement unit 21 uses a KPI calculation model (not illustrated) to calculate a KPI when the priority measure is executed. The KPI is a key performance indicator such as the sales amount and the number of customers visiting the stores.

The KPI calculation model is, for example, a function (a mathematical model) in which data regarding the target area, data regarding the target stores, and data regarding the target customer are input variables, and a predetermined KPI (for example, the sales amount) of the area is an output variable. The store placement unit 21 machine-learns the KPI calculation model using the purchase information 31, the OD information 32, and the movement information 33 that are used in the past as training data. For convenience of description, it is assumed that the user designates the sales amount as the KPI.

The store placement unit 21 inputs the input variables to the KPI calculation model after randomly changing the input variables as in the following <1> to <3>, for example, and acquires the sales amount of the area around the station A as the output variable.

<1> The store placement unit 21 allows a store in other areas to occupy a section in which no store in the area around the station A is occupied. It is preferable that the store to be occupied is the target store.

<2> The store placement unit 21 replaces stores among a plurality of sections in which the stores in the area around the station A are occupied. One of the stores to be replaced is preferably the target store.

<3> The store placement unit 21 sets an order among a plurality of stores placed in the area around the station A and adjusts timing of visiting each store of the customer.

That is, in the above <1> and <2>, the store placement unit 21 creates a large number of pieces of information (referred to as “store placement”) in which the location ID and the store ID are associated with each other as illustrated in FIG. 2, and sets each of the pieces of information as an input variable. In the above <3>, the store placement unit 21 creates a large number pieces of information (referred to as an “order of visit”) in which the order is associated with a predetermined number of stores that the target customer can visit continuously at a time, and sets each of the pieces of information as an input variable. It is preferable that the target store is included in the predetermined number of stores.

The sales amount of the area around the station A is a total sales amount of all the stores in the area. The store placement unit 21 finds a solution by which the store placement and the order of visit maximize the sales amount.

In step S205, the store placement unit 21 evaluates the KPI. Specifically, the maximum value of the sales amount calculated in step S204 is compared with a predetermined threshold.

In step S206, the store placement unit 21 checks whether the KPI exceeds the threshold. Specifically, when the maximum value of the sales amount exceeds the threshold (“Yes” in step S206), the store placement unit 21 holds the solution and proceeds to step S207, otherwise (“No” in step S206), the processing procedure ends.

In step S207, the store placement unit 21 creates the store guidance screen 51. Specifically, the store placement unit 21 creates, on a plane, the store guidance screen 51 (FIGS. 7 and 8) by displaying the target stores in the store placement that is the solution with icons and expressing the order of visit that is the solution with arrows. In FIGS. 7 and 8, there are three target stores displayed by icons, and there are four arrows. The store placement unit 21 may express all the stores, including the target stores, with friendly design icons. Further, the store placement unit 21 may highlight the stores whose placement are changed in any manner.

At this time, the point giving unit 22 of the area revitalization apparatus 1 associates the points (“5 points for every 100 yen of the amount of money of the product” or the like) given to the customer by each of the stores 52 to 57 according to the amount of money of the product with the icon of the respective store. Further, the point giving unit 22 also displays, on the store guidance screen 51, points (combination points) given to the customer when the customer visits and shops at all the target stores (the reference numeral 58). Furthermore, the point giving unit 22 also displays, on the store guidance screen 51, points (order points) given to the customer when the customer visits and shops at all the target stores in the order of visit indicated by the arrows (the reference numeral 58).

In step S208, the store placement unit 21 of the area revitalization apparatus 1 displays the store guidance screen 51. Specifically, the store placement unit 21 displays the store guidance screen 51 (FIGS. 7 and 8) on the customer terminal device 2 of the target customer.

Thereafter, the target customer gets off at the station A with reference to the store guidance screen 51 and visits the area around the station A. A result of shopping by the target customer at all stores including the target stores is accumulated as the purchase information 31 (FIG. 3), and a result of using the railway is accumulated as the OD information 32 (FIG. 4). Thereafter, it is assumed that a predetermined point giving time point (for example, the last day of each month) arrives.

In step S209, the point giving unit 22 of the area revitalization apparatus 1 acquires a purchase record. Specifically, the point giving unit 22 acquires the purchase information 31 from the store server 3, the OD information 32 from the transportation business operator server 4, and the movement information 33 from the communication business operator server 5, respectively, in the latest state.

In step S210, the point giving unit 22 gives the points. Specifically, first, the point giving unit 22 creates the point information 34 (FIG. 6) for one month with reference to the purchase information 31, the OD information 32, and the movement information 33. At this stage, the point field 140 and the accumulation point field 141 of the point information 34 are blank.

Second, the point giving unit 22 stores the points and the accumulation points corresponding to the amount of money in each record of the point information 34. When it is determined that the combination points and/or the order points can be given as a result of referring to the purchase information 31, the OD information 32, and the movement information 33, the point giving unit 22 adds the combination points and/or the order points to the points of the record of the store visited last.

Third, the point giving unit 22 transmits the accumulation points of the target customer to the customer terminal device 2 of the target customer. Thereafter, the processing procedure ends.

### (First Modification: Distance to Stagnant Location)

By referring to the movement information 33 (FIG. 5), the store placement unit 21 may specify a stagnant region where the flow of people particularly tends to be stagnant among the areas. The store placement unit 21 may place the target store in a section near the stagnant region. Further, the store placement unit 21 may calculate a past KPI (the customers visiting the stores or the like) for each store, and may determine a distance between the section in which the store is placed and the stagnant area to be larger or smaller as the KPI is larger.

### (Second Modification: Simultaneous Proposals to Multiple Target Customers)

The store placement unit 21 may simultaneously display different store guidance screens 51 (FIGS. 7 and 8) for a plurality of different target customers according to their attributes.

### (Third Modification: Nonlinear Point)

The point giving unit 22 may nonlinearly increase the points given to the customer with respect to a purchase amount of the product, in addition to linearly increasing the points given to the customer in proportion to the purchase amount of the product. Increasing nonlinearly means, for example, increasing in a higher order, exponentially, logarithmically, stepwise, or asymptotically to converge to a predetermined value. In this way, the point giving unit 22 can more accurately control motivation of the customer to shop at the store (both sales promotion and out-of-stock prevention).

### (Four Modification: Evaluation of KPI)

In the above description, the store placement unit 21 checks whether the KPI exceeds the threshold. Specifically, when the maximum value of the sales amount does not exceed the threshold (“Yes” in step S206), the store placement unit 21 holds the solution and proceeds to step S207, otherwise (“No” in Step S206), the processing procedure may end. That is, as a result of the simulation, the store placement unit 21 may determine to continue the processing when a large KPI can be expected, or may determine to continue the processing for real area revitalization when a large KPI cannot be expected.

### (Effects of Present Embodiment)

Effects of the area revitalization apparatus of the present embodiment are as follows.

(1) The area revitalization apparatus can guide a customer to a store and give an economic value to the customer.

(2) The area revitalization apparatus can guide the customer to the store whose placement is changed, and give the economic value to the customer.

(3) The area revitalization apparatus can determine the target store for the target customer.

(4) The area revitalization apparatus can cause the customer to visit a specific combination of stores in a specific order.

(5) The area revitalization apparatus can check whether to display a screen for guiding the customer to the store according to a magnitude of a KPI of a simulation result.

(6) The area revitalization apparatus can determine a distance between a region where the customer stagnates and the store according to the magnitude of the KPI of the store.

(7) The area revitalization apparatus can linearly or nonlinearly determine the economic value.

(8) The area revitalization apparatus can revitalize the area around the railway station.

The invention is not limited to the embodiment described above, and includes various modifications. For example, the above embodiment is described in detail for easy understanding of the invention, and the invention is not necessarily limited to those including all the configurations described above. A part of configurations of one embodiment can be replaced with configurations of another embodiment, and configurations of one embodiment can be added to configurations of another embodiment. A part of the configuration of each embodiment may be added to, deleted from, or replaced with another configuration.

What is claimed is:

1. An area revitalization apparatus comprising:
a store placement unit configured to change placement of a store in an area based on movement information on a customer and information on purchase of products by the customer, and display, to the customer, a screen for visiting the store in the area; and
a point giving unit configured to give an economic value to the customer who actually visits the store in the area.

2. The area revitalization apparatus according to claim 1, wherein
the store placement unit displays, to the customer, the screen for visiting the store whose placement is changed, and
the point giving unit gives the economic value to the customer who actually visits the store whose placement is changed.

3. The area revitalization apparatus according to claim 2, wherein
the store placement unit determines a target customer having a certain attribute and a target store for the target customer based on the movement information on the customer and the information on the purchase of the products by the customer.

4. The area revitalization apparatus according to claim 3, wherein
the store placement unit determines a combination of a plurality of the stores and an order of visit to the stores, and
the point giving unit gives the economic value to the customer who visits all the stores included in the combination, or to the customer who visits all the stores included in the combination in the order.

5. The area revitalization apparatus according to claim 4, wherein
the store placement unit calculates a key performance indicator of the store whose placement is changed, and checks whether to display, to the customer, the screen for visiting the store whose placement is changed, based on a magnitude relation between the calculated key performance indicator and a predetermined threshold.

6. The area revitalization apparatus according to claim 5, wherein
the store placement unit determines a distance between a region where movement of the customer is stagnant and the target store according to the key performance indicator of the store.

7. The area revitalization apparatus according to claim 6, wherein
the point giving unit linearly or nonlinearly calculates the economic value according to a purchase amount in the store.

8. The area revitalization apparatus according to claim 7, wherein
the area is around a railway station.

9. An area revitalization method executed by an area revitalization apparatus, the method comprising:
changing, by a store placement unit of the area revitalization apparatus, a placement of a store in an area based on movement information on a customer and purchase information on products by the customer, and displaying, to the customer, a screen for visiting the store in the area; and
giving, by a point giving unit of the area revitalization apparatus, an economic value to the customer who actually visits the store in the area.
